(19) United States
(12) Patent Application Publication
(10) Pub. No.: US 2019/0020273 A1
(43) Pub. Date: Jan. 17, 2019

(54) VOLTAGE SYSTEM AND METHOD FOR OPERATING THE SAME

(71) Applicant: NANYA TECHNOLOGY CORPORATION, NEW TAIPEI CITY (TW)

(72) Inventor: Ting-Shuo HSU, NEW TAIPEI CITY (TW)

(21) Appl. No.: 15/651,516

(22) Filed: Jul. 17, 2017

(51) Int. Cl. H02M 3/07

(52) U.S. Cl. CPC H02M 3/07

(57) ABSTRACT

The present disclosure provides a voltage system and a method for operating the same. The voltage system includes a pump system. The pump system includes a first charging path, a second charging path and a load capacitor. The load capacitor is chargeable in combination with the first charging path and the second charging path in an alternate manner. The first charging path exhibits a first capacitance when a voltage level of a supply voltage of the pump system is greater than a reference voltage level, and exhibits a second capacitance greater than the first capacitance when the voltage level of the supply voltage is less than the reference voltage level.

### TECHNICAL FIELD

The present disclosure relates to a voltage system, and more particularly, to a voltage system providing a pump voltage which serves as a supply voltage for the electrical components of a memory device, and to a method for operating the same.

### DISCUSSION OF THE BACKGROUND

Voltage regulators (VRs) are generally used in power delivery applications in which an input voltage needs to be transformed to an output voltage in ratios that range from smaller than unity to greater than unity.

This Discussion of the Background section is provided for background information only. The statements in this Discussion of the Background are not an admission that the subject matter disclosed in this section constitutes prior art to the present disclosure, and no part of this section may be used as an admission that any part of this application, including this Discussion of the Background section, constitutes prior art to the present disclosure.

### SUMMARY

One aspect of the present disclosure provides a voltage system. The voltage system includes a pump system. The pump system includes a first charging path, a second charging path and a load capacitor. The load capacitor is chargeable in combination with the first charging path and the second charging path in an alternate manner. The first charging path exhibits a first capacitance when a voltage level of a supply voltage of the pump system is greater than a reference voltage level, and exhibits a second capacitance greater than the first capacitance when the voltage level of the supply voltage is less than the reference voltage level.

In some embodiments, the voltage system further comprises a sensing device configured to compare the voltage level of the supply voltage to the reference voltage level, wherein the first charging path exhibits one of the first capacitance and the second capacitance based on the comparison result.

In some embodiments, the second charging path is configured to exhibit the first capacitance when the voltage level of the supply voltage is greater than the reference voltage level, and to exhibit the second capacitance when the voltage level of the supply voltage is less than the reference voltage level.

In some embodiments, the voltage system further comprises a switch device configured to couple the load capacitor to the first charging path and couple the load capacitor to the second charging path in an alternate manner.

In some embodiments, the first charging path and the load capacitor are charged by means of a first clock signal, and the second charging path and the load capacitor are charged by means of a second clock signal, wherein the second clock signal is an inverted clock signal of the first clock signal.

In some embodiments, the first charging path includes a first capacitor and a first auxiliary capacitor. The first auxiliary capacitor is configured to be connected in parallel with the first capacitor with respect to the load capacitor when the voltage level of the supply voltage is less than the reference voltage level.

In some embodiments, the first charging path further includes a first switch configured to connect the first capacitor to the first auxiliary capacitor in parallel with respect to the load capacitor when the voltage level of the supply voltage is less than the reference voltage level.

In some embodiments, the first switch and the first auxiliary capacitor are connected in series with respect to the load capacitor.

In some embodiments, the voltage system further comprises a sensing device configured to compare the voltage level of the supply voltage to the reference voltage level, wherein the first switch either connects or disconnects the first capacitor to the first auxiliary capacitor based on the comparison result.

In some embodiments, the second charging path includes a second capacitor and a second auxiliary capacitor. The second auxiliary capacitor is configured to be connected in parallel with the second capacitor with respect to the load capacitor when the voltage level of the supply voltage is less than the reference voltage level.

In some embodiments, the second charging path further includes a second switch configured to connect the second capacitor to the second auxiliary capacitor in parallel with respect to the load capacitor when the voltage level of the supply voltage is less than the reference voltage level.

In some embodiments, the voltage system further comprises a sensing device configured to compare the voltage level of the supply voltage to the reference voltage level. The first switch either connects or disconnects the first capacitor to the first auxiliary capacitor based on the comparison result, and the second switch either connects or disconnects the second capacitor to the second auxiliary capacitor based on the comparison result.

Another aspect of the present disclosure provides a voltage system. The voltage system includes a pump system. The pump system includes a first charging path, a second charging path and a load capacitor. The first charging path includes a first capacitor, a first auxiliary capacitor and a first transistor. A terminal of the first auxiliary capacitor is coupled to a terminal of the first capacitor. A source of the first transistor is coupled to the other terminal of the first capacitor and a drain of the first transistor being coupled to the other terminal of the first auxiliary capacitor. The load capacitor is chargeable in combination with the first charging path and the second charging path in an alternate manner. The load capacitor is coupled to the terminals of the first capacitor and the first auxiliary capacitor when the load capacitor is charged in combination with the first charging path.

In some embodiments, the source of the first transistor is directly coupled to the other terminal of the first capacitor, and the drain of the first transistor is directly coupled to the other terminal of the first auxiliary capacitor.

In some embodiments, the terminal of the first capacitor is directly coupled to the terminal of the first auxiliary capacitor.

In some embodiments, the voltage system further comprises a sensing device configured to compare the voltage level of the supply voltage to the reference voltage level, and control the conduction state of the first transistor by controlling a gate voltage of a gate of the first transistor based on the comparison result.

In some embodiments, the second charging path includes a second capacitor, a second auxiliary capacitor and a second transistor. A terminal of the second auxiliary capacitor is coupled to a terminal of the second capacitor. The source of the second transistor is coupled to the other terminal of the second capacitor and a drain of the second transistor is coupled to the other terminal of the second auxiliary capacitor.

In some embodiments, the pump system further comprises a first switch transistor, a second switch transistor, a third switch transistor and a fourth switch transistor. The second switch transistor is connected in series with the first switch transistor with respect to the load capacitor, wherein the connected first and second switch transistors are coupled between the terminals of the first capacitor and the load capacitor when the load capacitor is charged in combination with the first charging path. The fourth switch transistor is connected in series with the third switch transistor with respect to the load capacitor, wherein the connected third and fourth switch transistors are coupled between the terminals of the second capacitor and the load capacitor when the load capacitor is charged in combination with the second charging path.

Another aspect of the present disclosure provides a method of operating a voltage system. The method includes providing a supply voltage of the voltage system by alternately charging a first capacitor having a first capacitance and a second capacitor having the first capacitance until a voltage level of the supply voltage is less than a reference voltage level; increasing the first capacitance to a second capacitance when the voltage level of the supply voltage is less than the reference voltage level; and providing the supply voltage by alternately charging the first capacitor which has the second capacitance and the second capacitor which has the second capacitance.

In some embodiments, it is determined whether the voltage level of the supply voltage is less than the reference voltage level.

In the present disclosure, since a first charging path and a second charging path have relatively great capacitance, current charging a load capacitor is relatively great. As a result, a relatively short time is required to increase a supply voltage from a drastically reduced voltage level of about 1.5V back to a desired voltage level of about 3.0V

In contrast, in the comparative pump system, in a scenario, a supply voltage of a voltage system may drop drastically. However, total capacitance associated with a first charging path, or a second charging path in such a scenario, equals the capacitance in a circumstance when the voltage level of the supply voltage is only slightly reduced for example, from about 3.0V to about 2.8V. As a result, current in such a scenario equals to that in the circumstance. In that case, a relatively long time is required to increase the supply voltage Vpump0 from a drastically reduced voltage level of about 1.5V back to a desired voltage level of about 3.0V.

The foregoing has outlined rather broadly the features and technical advantages of the present disclosure in order that the detailed description of the disclosure that follows may be better understood. Additional features and advantages of the disclosure are described hereinafter, and form the subject of the claims of the disclosure. It should be appreciated by those skilled in the art that the conception and specific embodiment disclosed may be readily utilized as a basis for modifying or designing other structures or processes for carrying out the purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

A more complete understanding of the present disclosure may be derived by referring to the detailed description and claims when considered in connection with the Figures, where like reference numbers refer to similar elements throughout the Figures, and:

FIG. 1 is a schematic diagram of a comparative voltage system including a pump system.

FIG. 2 is a circuit diagram of an equivalent circuit of the pump system, shown in FIG. 1, operating in a first phase.

FIG. 3 is a circuit diagram of an equivalent circuit of the pump system, shown in FIG. 1, operating in a second phase.

FIG. 4 is a schematic diagram of a voltage system including a pump system, in accordance with an embodiment of the present disclosure.

FIG. 5 is a circuit diagram of an equivalent circuit of the pump system, shown in FIG. 4, operating in a first phase, in accordance with an embodiment of the present disclosure.

FIG. 6 is a circuit diagram of an equivalent circuit of the pump system, shown in FIG. 4, operating in a second phase, in accordance with an embodiment of the present disclosure.

FIG. 7 is a circuit diagram of an equivalent circuit of the pump system, shown in FIG. 4, operating in the first phase, in accordance with an embodiment of the present disclosure.

FIG. 8 is a circuit diagram of an equivalent circuit of the pump system, shown in FIG. 4, operating in the second phase, in accordance with an embodiment of the present disclosure.

FIG. 9 is a schematic diagram of a voltage system including a pump system, in accordance with an embodiment of the present disclosure.

FIG. 10 is a circuit diagram of an equivalent circuit of the pump system, shown in FIG. 9, operating in a first phase, in accordance with an embodiment of the present disclosure.

FIG. 11 is a circuit diagram of an equivalent circuit of the pump system, shown in FIG. 9, operating in the first phase, in accordance with an embodiment of the present disclosure.

FIG. 12 is a circuit diagram of an equivalent circuit of the pump system, shown in FIG. 9, operating in a second phase, in accordance with an embodiment of the present disclosure.

FIG. 13 is a circuit diagram of an equivalent circuit of the voltage system, shown in FIG. 9, operating in the second phase, in accordance with an embodiment of the present disclosure.

FIG. 14 is a schematic diagram of a voltage system including a pump system, in accordance with an embodiment of the present disclosure.

FIG. 15 is a flow diagram illustrating a method of operating a voltage system, in accordance with an embodiment of the present disclosure.

### DETAILED DESCRIPTION

Embodiments, or examples, of the disclosure illustrated in the drawings are now described using specific language. It shall be understood that no limitation of the scope of the disclosure is thereby intended. Any alteration or modification to the described embodiments, and any further applications of principles described in this document, are to be considered as normally occurring to one of ordinary skill in the art to which the disclosure relates. Reference numerals may be repeated throughout the embodiments, but this does not necessarily require that feature(s) of one embodiment apply to another embodiment, even if they share the same reference numeral.

It shall be understood that when an element is referred to as being “connected to” or “coupled with” another element, it may be directly connected to or coupled to the other element, or intervening elements may be present.

It shall be understood that, although the terms first, second, third, etc. may be used herein to describe various elements, components, regions, layers or sections, these elements, components, regions, layers or sections should not be limited by these terms. Rather, these terms are merely used to distinguish one element, component, region, layer or section from another region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It shall be further understood that the terms “comprises” and “comprising,” when used in this specification, specify the presence of stated features, integers, steps, operations, elements, or components, but do not preclude the presence or addition of one or more other features, integers, steps, operations, elements, components, or groups thereof.

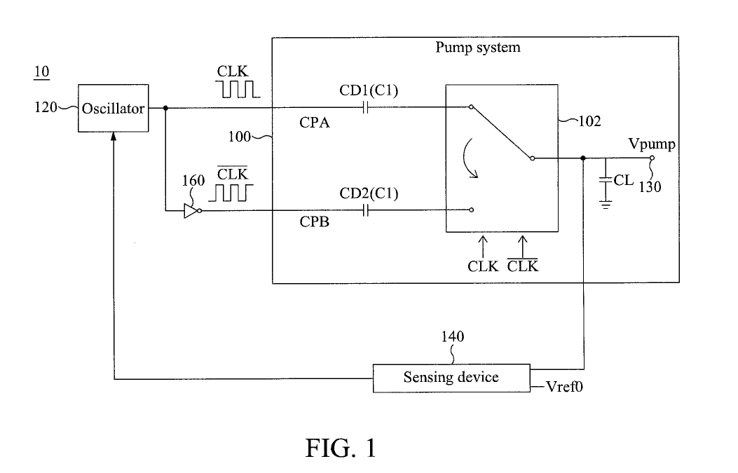

FIG. 1 is a schematic diagram of a comparative voltage system 10 including a pump system 100. Referring to FIG. 1, in addition to the pump system 100, the voltage system 10 further includes an oscillator 120, a sensing device 140 and an inverter 160.

The oscillator 120 provides a first clock signal CLK to the pump system 100, and to the inverter 160 functioning to invert the first clock signal CLK to a second clock signal C̅L̅K̅.

The pump system 100 provides a supply voltage Vpump0 of the voltage system 10 by using the first clock signal CLK and the second clock signal C̅L̅K̅, which will be described in detail below.

The sensing device 140 functions to compare the voltage level of the supply voltage Vpump0 at an output 130 of the pump system 130 to a reference voltage level Vref0, and determine whether the voltage level of the supply voltage Vpump0 is reduced based on the comparison result, thereby determining to activate or deactivate the oscillator 120. When the voltage level of the supply voltage Vpump0 is greater than the reference voltage Vref0, the sensing device 140 deactivates the oscillator 120. Alternatively, when the voltage level of the supply voltage Vpump0 is less than the reference voltage Vref0, the sensing device 140 activates the oscillator 120, thereby activating the pump system 100 to increase the voltage level of the supply voltage Vpump0.

The pump system 100 includes a first charging path CPA including a first capacitor CD1 having a first capacitance C1, a second charging path CPB including a second capacitor CD2 having the first capacitance C1, a switch device 102 and a load capacitor CL.

The switch device 102, based on logical levels of the first clock signal CLK and the second clock signal C̅L̅K̅, couples the load capacitor CL to the first charging path CPA and couples the load capacitor CL to the second charging path CPB in an alternate manner. In further detail, operation of the pump system 100 includes two phases, a first phase and a second phase.

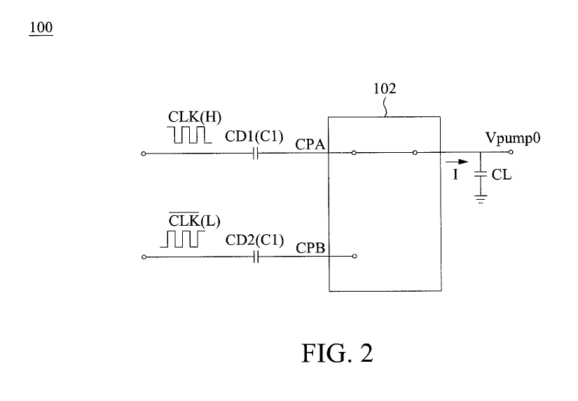

In the first phase, the switch device 102 couples the first charging path CPA to the load capacitor CL. As a result, the first charging path CPA and the load capacitor CL are charged by means of the first clock signal CLK. An equivalent circuit of the pump system 100 operating in the first phase is illustrated in FIG. 2.

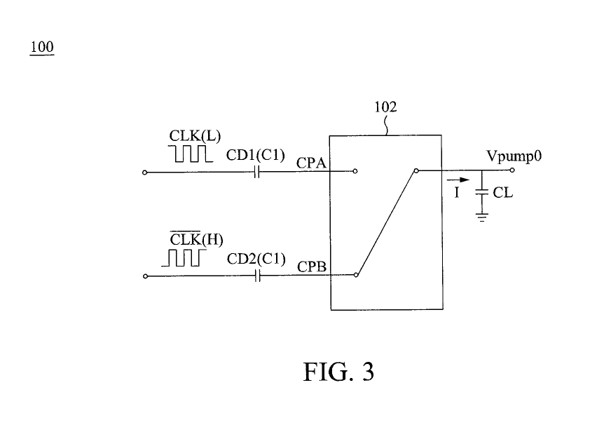

In the second phase, the switch device 102 couples the second charging path CPB to the load capacitor CL. As a result, the second charging path CPB and the load capacitor CL are charged by means of the second clock signal C̅L̅K̅. An equivalent circuit of the pump system 100 operating in the second phase is illustrated in FIG. 3.

For convenience, a same reference numeral or label is used to refer to a capacitor or, when appropriate, its capacitance throughout the disclosure, and vice versa. For example, while the reference label “CL” as above mentioned refers to a capacitor, it may also represent its capacitance.

FIG. 2 is a circuit diagram of an equivalent circuit of the pump system 100, shown in FIG. 1, operating in the first phase. Referring to FIG. 2, the first clock signal CLK exhibits a first logic level H, and the second clock signal C̅L̅K̅ exhibits a second logic level L. In an embodiment, the first logic level H refers to logically high, and the second logic level L refers to logically low. Because of the first logic level H of the first clock signal CLK and the second logic level L of the second clock signal C̅L̅K̅, the switch device 102 couples the first charging path CPA to the load capacitor CL. In that case, the first capacitor CD1 and the load capacitor CL are charged by the first clock signal CLK exhibiting the first logic level H. Current I conducting through the first capacitor CD1 and the load capacitor CL can be expressed in equation (1) below.

$$\begin{matrix}I = Ctotal \frac{d ( H )}{dt} \\ = ( \frac{1}{\frac{1}{C 1} + \frac{1}{CL}} ) \frac{d ( H )}{dt}\end{matrix} \qquad ( 1 )$$

Where Ctotal represents a total capacitance associated with a path which the current I conducts through.

Variation, in time domain, of the supply voltage Vpump0 can be expressed in equation (2) below.

$$I = CL \frac{{dV}_{pump} 0}{dt} \qquad ( 2 )$$

In a scenario, the supply voltage Vpump0 of the voltage system 10 may drop drastically. For example, it is assumed that the supply voltage Vpump0 serves as a supply voltage for a load. When an operation mode of the load changes from a light-load mode to a heavy-load mode, the supply voltage Vpump0 may drop drastically, for example, from about 3.0V to about 1.5V. However, the total capacitance, Ctotal in such scenario, is equal to that in a circumstance when the voltage level of the supply voltage Vpump0 is only slightly reduced, for example, from about 3.0V to about 2.8V. Further, the term

$$( \frac{d ( H )}{dt} )$$

is fixed because, for example, the first clock signal CLK is provided and controlled by the oscillator 120. As a result, in view of equation (1), the current I in such scenario is equal to that in the circumstance.

In addition, since the current I and the capacitance CL in such scenario as mentioned above are equal to those in the circumstance, in view of equation (2) the term

$$( \frac{{dV}_{pump} 0}{dt} )$$

in such scenario therefore equals to that in the circumstance. That is, the voltage level of the supply voltage Vpump0 in such scenario increases in the same manner as that in the circumstance. In that case, a relatively long time is required to increase the supply voltage Vpump0 from a drastically reduced voltage level of about 1.5V back to a desired voltage level of about 3.0V.

Moreover, in view of equation (2), a relatively great current I decreases a time for increasing a voltage level of the supply voltage Vpump0. Further in view of equation (1), a possible way to increase the current I is to increase capacitance associated with the first charging path CPA in the first phase.

FIG. 3 is a circuit diagram of an equivalent circuit of the pump system 100, shown in FIG. 1, operating in the second phase. Referring to FIG. 3, the first clock signal CLK exhibits the second logic level L, and the second clock signal C̅L̅K̅ exhibits the first logic level H. Because of the second logic level L of the first clock signal CLK and the first logic level H of the second clock signal C̅L̅K̅, the switch device 102 couples the second charging path CPB to the load capacitor CL. In that case, the second capacitor CD2 and the load capacitor CL are charged by the second clock signal C̅L̅K̅ exhibiting the first logic level H. Equation expressing current I conducting through the second capacitor CD2 and the load capacitor CL is the same as equation (1). As a result, the currents I equal in both the first phase and the second phase. In view of equation (1), a possible way to increase the current I is to increase capacitance associated with the second charging path CPB in the second phase.

The first phase and the second phase are repeatedly performed. Accordingly, the load capacitor CL keeps charging with the first logic level H. By doing so, the pump system 100 is able to provide the supply voltage Vpump0.

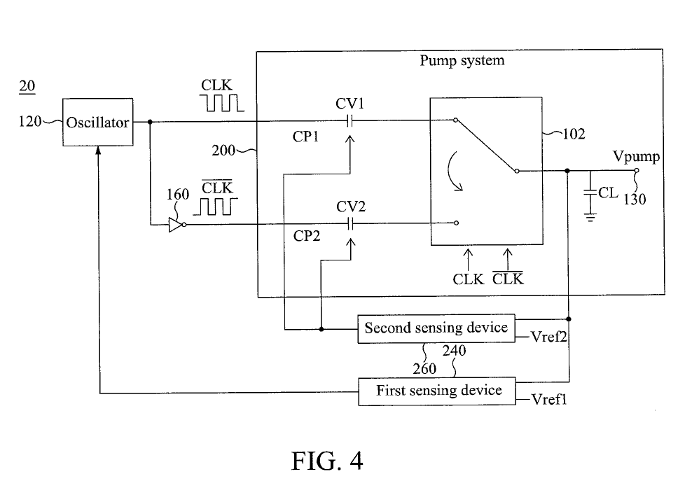

FIG. 4 is a schematic diagram of a voltage system 20 including a pump system 200, in accordance with an embodiment of the present disclosure. For convenience of discussion, the sensing device 140 illustrated and described with reference to FIG. 1 is renamed and renumbered as the first sensing device 240; and the reference voltage level Vref0 illustrated and described with reference to FIG. 1 is renamed and renumbered as the first reference voltage level Vref1.

Referring to FIG. 4, the voltage system 20 is similar to the voltage system 10 described and illustrated with reference to FIG. 4 except that, for example, the voltage system 20 includes a second sensing device 260 in addition to the pump system 200. The pump system 200 includes a first charging path CP1 including a first capacitor CV1 and a second charging path CP2 including a second capacitor CV2.

The second sensing device 260 compares the voltage level of the supply voltage Vpump to a second reference voltage level Vref2 less than the first reference voltage level Vref1, and determines whether the voltage level of the supply voltage Vpump0 is reduced drastically based on the comparison result. In an embodiment, the first reference voltage level Vref1 is about 2.9V, and the second reference voltage level Vref2 is about 2.5V.

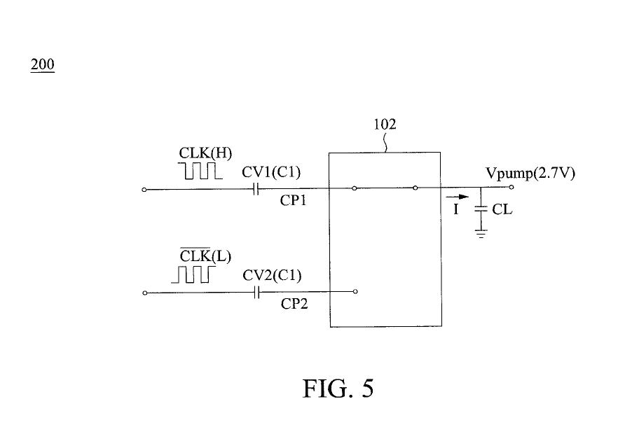

The first capacitor CV1 is adjustable in capacitance, and is adjusted in response to the comparison result from the second sensing device 260. In further detail, the first capacitor CV1 exhibits one of a first capacitance C1 and a second capacitance C2 greater than the first capacitance C1 based on the comparison result, which will be illustrated with reference to FIGS. 5 to 8. In an embodiment, the first capacitor CV1 includes a variable capacitor.

The second capacitor CV2 is adjustable in capacitance, and is adjusted in response to the comparison result from the second sensing device 260. In further detail, the second capacitor CV2 exhibits one of the first capacitance C1 and the second capacitance C2 based on the comparison result, which will be illustrated with reference to FIGS. 5 to 8. In an embodiment, the second capacitor CV2 includes a variable capacitor.

The load capacitor CL is chargeable in combination with the first charging path CP1 and the second charging path CP2 in an alternate manner, which will be illustrated with reference to FIGS. 5 to 8.

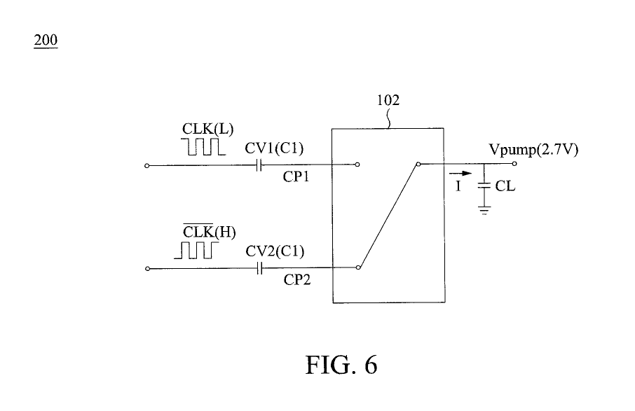

FIG. 5 is a circuit diagram of an equivalent circuit of the pump system 200, shown in FIG. 4, operating in a first phase, in accordance with an embodiment of the present disclosure. FIG. 6 is a circuit diagram of an equivalent circuit of the pump system 200, shown in FIG. 4, operating in a second phase, in accordance with an embodiment of the present disclosure. It is assumed that the first reference voltage level Vref1 is about 2.9V, and the second reference voltage level Vref2 is about 2.5V.

Referring to FIG. 5, a scenario in which the voltage level of the supply voltage Vpump is slightly reduced from the desired voltage level of about 3.0V to a voltage level of about 2.7V is illustrated. Capacitances of the first capacitor CV1 and the second capacitor CV2 are adjusted to the first capacitance C1 in response to the comparison result, which indicates that the voltage level of a supply voltage Vpump is less than the first reference voltage level Vref1 while greater than the second reference voltage level Vref2, from the second sensing device 260. As a result, both the first capacitor CV1 and the second capacitor CV2 exhibit the same first capacitance C1. In this case, operation of the pump system 200 shown in FIG. 5 is substantially the same as that of the pump system 100 described and illustrated with reference to FIG. 2. Similarly, operation of the pump system 200 shown in FIG. 6 is substantially the same as that of the pump system 100 described and illustrated with reference to FIG. 3.

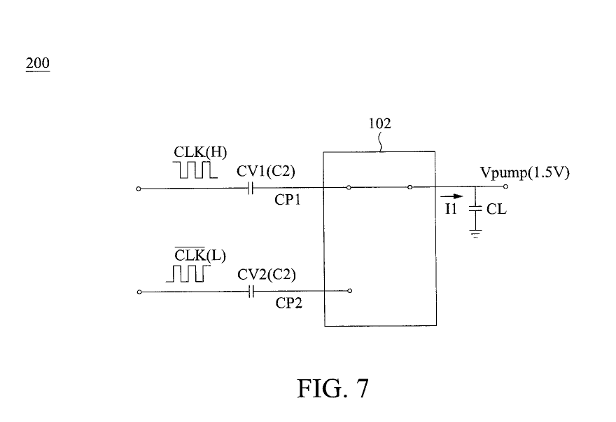

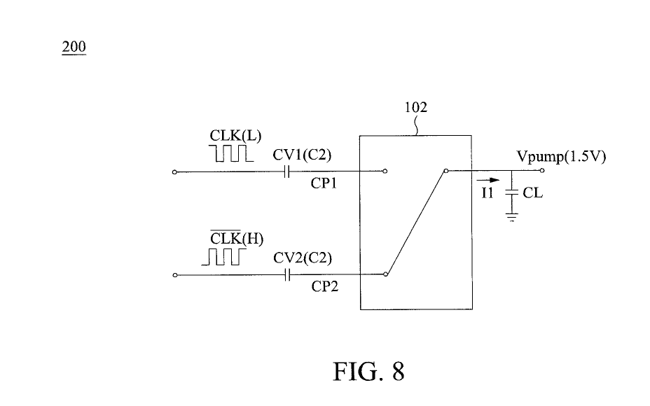

FIG. 7 is a circuit diagram of an equivalent circuit of the pump system 200, shown in FIG. 4, operating in the first phase, in accordance with an embodiment of the present disclosure. FIG. 8 is a circuit diagram of an equivalent circuit of the pump system 200, shown in FIG. 4, operating in the second phase, in accordance with an embodiment of the present disclosure. It is assumed that the first reference voltage level Vref1 is about 2.9V, and the second reference voltage level Vref2 is about 2.5V.

Referring to FIG. 7, a scenario in which the voltage level of the supply voltage Vpump is drastically reduced from the desired voltage level of about 3.0V to a voltage level of about 1.5V is illustrated. In an example of the scenario, the supply voltage Vpump serves as a supply voltage for a load. When an operation mode of the load changes from a light-load mode to a heavy-load mode, the supply voltage Vpump may drop drastically, for example, from about 3.0V to about 1.5V, which is less than not only the first reference voltage level Vref1 of about 2.9V but also the second reference voltage level Vref2 of 2.5V.

Capacitances of the first capacitor CV1 and the second capacitor CV2 are adjusted to the second capacitance C2 in response to the comparison result, which indicates that the voltage level of a supply voltage Vpump is less than not only the first reference voltage level Vref1 but also the second reference voltage level Vref2, from the second sensing device 260. As a result, both the first capacitor CV1 and the second capacitor CV2 exhibit the same second capacitance C2. Current I1 conducting through the first capacitor CV1 and the load capacitor CL can be expressed in equation (3) below.

$$\begin{matrix}I 1 = Ctotal 1 \frac{d ( H )}{dt} \\ = ( \frac{1}{\frac{1}{C 2} + \frac{1}{CL}} ) \frac{d ( H )}{dt}\end{matrix} \qquad ( 3 )$$

Where Ctotal1 represents a total capacitance associated with a path which the current I1 conducs through.

Compared equation (3) with equation (1), since the second capacitance C2 is greater than the first capacitance C1 and therefore the current I1 is greater than the current I, as previously discussed a relatively short time is required to increase the supply voltage Vpump from a drastically reduced voltage level of about 1.5V back to a desired voltage level of about 3.0V. Operation shown in FIG. 8 is similar to that shown in FIG. 7. Therefore, the detailed descriptions are omitted herein.

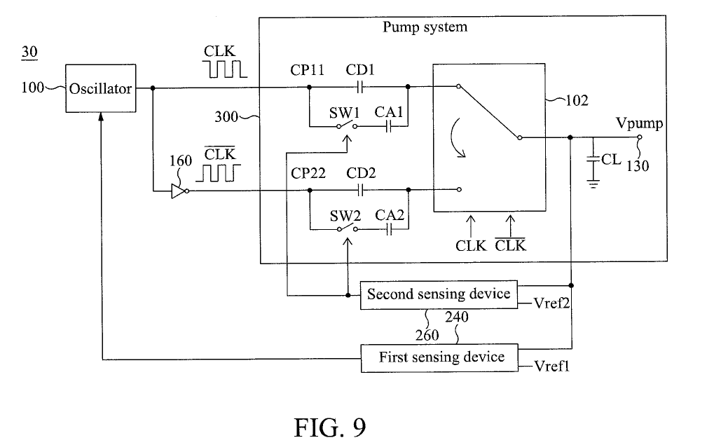

FIG. 9 is a schematic diagram of a voltage system 30 including a pump system 300, in accordance with an embodiment of the present disclosure. Referring to FIG. 9, the pump system 300 is similar to the pump system 200 described and illustrated with reference to FIG. 4 except that, for example, the pump system 300 includes a first path C11 including a first switch SW1 and a first auxiliary capacitor CA1, and a second path C22 including a second switch SW2 and a second auxiliary capacitor CA2.

The first auxiliary capacitor CA1 is connected in parallel with the first capacitor CD1 with respect to the load capacitor CL when the voltage level of the supply voltage Vpump is less than the second reference voltage level Vref2.

The first switch SW1 and the first auxiliary capacitor CA1 are connected in series with respect to the load capacitor CL, and functions to either connect or disconnect the first auxiliary capacitor CA1 to the first capacitor CD1 based on the comparison result from the second sensing device 260. In an embodiment, the first switch SW1 connects the first auxiliary capacitor CA1 to the first capacitor CD1 in parallel with respect to the load capacitor CL when the comparison result indicates that the voltage level of the supply voltage Vpump is less than the second reference voltage level Vfer2.

The second auxiliary capacitor CA2 is connected in parallel with the second capacitor CD2 with respect to the load capacitor CL when the voltage level of the supply voltage Vpump is less than the second reference voltage level Vref2.

The second switch SW2 and the second auxiliary capacitor CA2 are connected in series with respect to the load capacitor CL, and functions to either connect or disconnect the second auxiliary capacitor CA2 to the second capacitor CD2 based on the comparison result from the second sensing device 260. In an embodiment, the second switch SW2 connects the second auxiliary capacitor CA2 CD2 to the second capacitor in parallel with respect to the load capacitor CL when the comparison result indicates that the voltage level of the supply voltage Vpump is less than the second reference voltage level Vfer2.

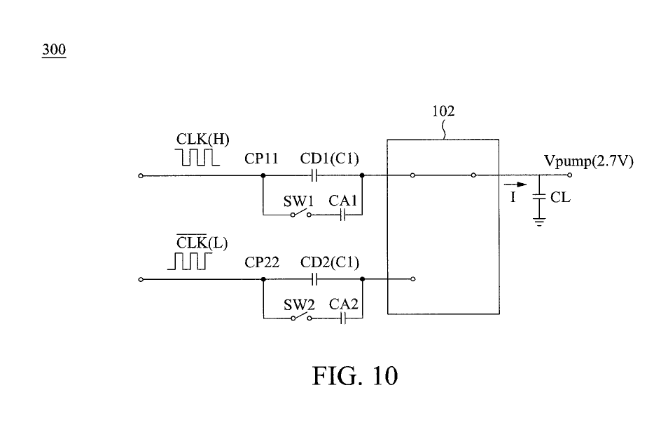

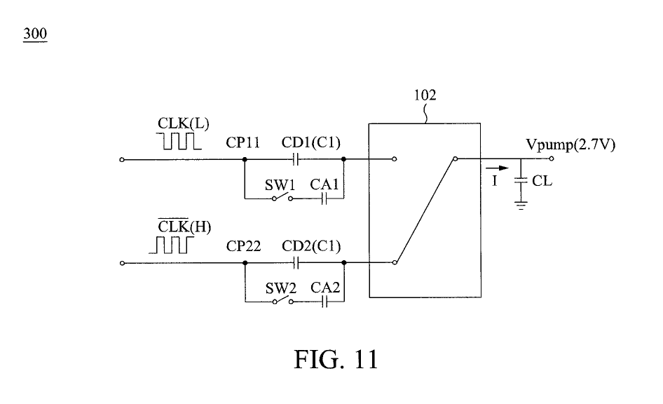

FIG. 10 is a circuit diagram of an equivalent circuit of the pump system 300, shown in FIG. 9, operating in a first phase, in accordance with an embodiment of the present disclosure. FIG. 11 is a circuit diagram of an equivalent circuit of the pump system 300, shown in FIG. 9, operating in a second phase, in accordance with an embodiment of the present disclosure. It is assumed that the first reference voltage level Vref1 is about 2.9V, and the second reference voltage level Vref2 is about 2.5V.

Referring to FIGS. 10 and 11, a scenario in which the voltage level of the supply voltage Vpump is slightly reduced from the desired voltage level of about 3.0V to a voltage level of about 2.7V is illustrated. In this case, operations shown in FIGS. 10 and 11 are the same as those shown in FIGS. 2 and 3. Therefore, the detailed descriptions are omitted herein.

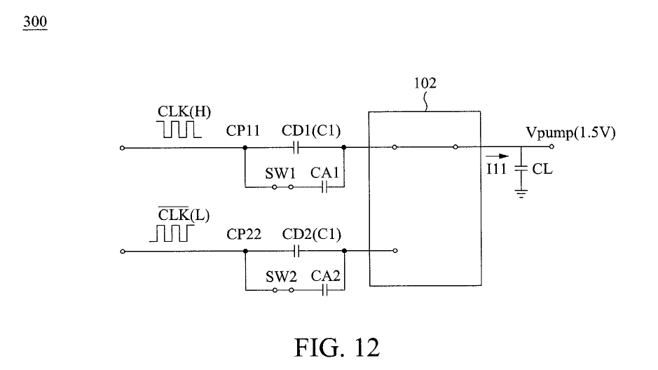

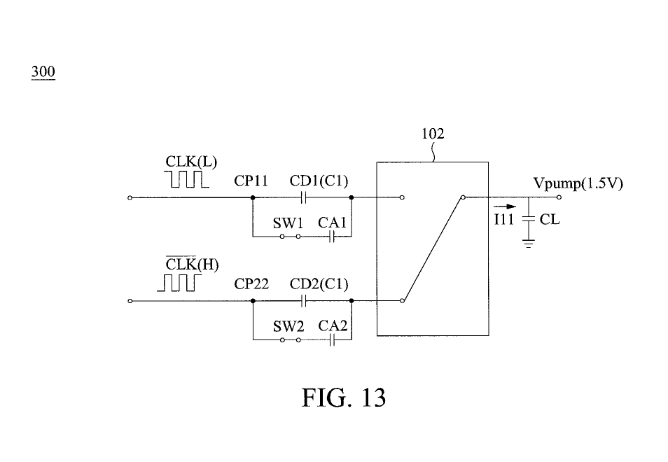

FIG. 12 is a circuit diagram of an equivalent circuit of the pump system 300, shown in FIG. 9, operating in a second phase, in accordance with an embodiment of the present disclosure. FIG. 13 is a circuit diagram of an equivalent circuit of the voltage system 300, shown in FIG. 9, operating in the second phase, in accordance with an embodiment of the present disclosure.

Referring to FIG. 12, a scenario in which the voltage level of the supply voltage Vpump is drastically reduced from the desired voltage level of about 3.0V to a voltage level of about 1.5V is illustrated. The first switch SW1 connects the first capacitor CD1 and the first auxiliary capacitor CA1 in parallel with respect to the load capacitor CL. Current I11 conducting through the first capacitor CD1, the first auxiliary capacitor CA1 and the load capacitor CL can be expressed in equation (4) below.

$$\begin{matrix}I 11 = Ctotal 11 \frac{d ( H )}{dt} \\ = ( \frac{1}{\frac{1}{C 1 + CA 1} + \frac{1}{CL}} ) \frac{d ( H )}{dt}\end{matrix} \qquad ( 4 )$$

Where Ctotal11 represents a total capacitance associated with a path which the current I11 conducts through.

Compared equation (4) with equation (1), since denominator of the term

$$“ \frac{1}{C 1 + CA 1} ”$$

is greater than that of the term

$$“ \frac{1}{C 1} ”$$

and therefore the current I11 is greater than the current I. As previously discussed, a relatively short time is required to increase the supply voltage Vpump from a drastically reduced voltage level of about 1.5V back to a desired voltage level of about 3.0V. Operation shown in FIG. 13 is similar to that shown in FIG. 12. Therefore, the detailed descriptions are omitted herein.

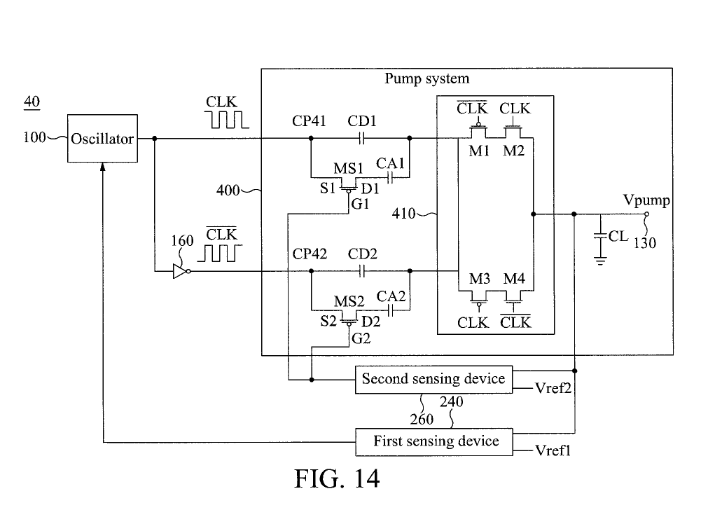

FIG. 14 is a schematic diagram of a voltage system 40 including a pump system 400, in accordance with an embodiment of the present disclosure. Referring to FIG. 14, the pump system 400 is similar to the pump system 300 described and illustrated with reference to FIG. 9 except that, for example, the pump system 400 includes a first charging path CP41 including a first transistor MS1, a second charging path CP42 including a second transistor MS2, a switch device 410 including a first switch transistor M1, a second switch transistor M2, a third switch transistor M3 and a fourth switch transistor M4.

The first transistor MS1 has a source S1, a drain D1 and a gate G1. The source and drain S1 and D1 of the first transistor MS1 are coupled to terminals of the first capacitor and first auxiliary capacitor CD1 and CA1, respectively. The other terminals of the first auxiliary capacitor and first capacitor CA1 and CD1 are coupled to each other. In an embodiment, the source and drain S1 and D1 of the first transistor MS1 are directly coupled to terminals of the first capacitor and first auxiliary capacitor CD1 and CA1, respectively. In addition, the other terminals of the first auxiliary capacitor and first capacitor CA1 and CD1 are directly coupled to each other.

The second transistor MS2 has a source S2, a drain D2 and a gate G2. The source S2 of the second transistor MS2 is coupled to a terminal of the second capacitor CD2 and the drain D2 of the second transistor MS2 is coupled to a terminal of the second auxiliary capacitor CA2. The other terminal of the second auxiliary capacitor CA2 is coupled to the other terminal of the second capacitor CD2. In an embodiment, the source S2 of the second transistor MS2 is directly coupled to the terminal of the second capacitor CD2, and the drain D2 of the second transistor MS2 is directly coupled to the terminal of the second auxiliary capacitor CA2. In addition, the other terminal of the second capacitor CD2 is directly coupled to the other terminal of the second auxiliary capacitor CA2.

Operation of the second sensing device 260 is similar to that of the second sensing device 260 described and illustrated with reference to FIG. 9 except that, for example, the second sensing device 260 further controls the conduction state of the first and second transistors MS1 and MS2 by controlling a gate voltage of each of the gates G1 and G2 of the first and second transistors MS1 and MS2 based on the comparison result.

The load capacitor CL is coupled to the other terminals of the first capacitor and first auxiliary capacitor CD1 and CA1 when the load capacitor CL is charged in combination with the first charging path CP41. Similarly, the load capacitor CL is coupled to the other terminals of the second capacitor and second auxiliary capacitor CD2 and CA2 when the load capacitor CL is charged in combination with the second charging path CP42.

The first switch transistor M1 is connected in series with the second switch transistor M2 with respect to the load capacitor CL. The connected first and second switch transistor M1 and M2 is coupled between the other terminal of the first capacitor CD1 and the load capacitor CL when the load capacitor CL is charged in combination with the first charging path CP41.

The third switch transistor M3 is connected in series with the fourth switch transistor M4 with respect to the load capacitor CL. The connected third and fourth switch transistor M3 and M4 is coupled between the other terminal of the second capacitor CD2 and the load capacitor CL when the load capacitor CL is charged in combination with the second charging path CP42.

In operation, when the first clock signal CLK exhibits the first logical level H and the second clock signal C̅L̅K̅ exhibits the second logical level L, the first and second switch transistors M1 and M2 are conducted while the third and fourth switch transistors M3 and M4 are not conducted. The equivalent circuit of the pump system 400 in this case is substantially the same as that shown either in FIG. 10 or 12, depending on the conduction state of the first and second transistors MS1 and MS2. Alternatively, when the first clock signal CLK exhibits the second logical level L and the second clock signal C̅L̅K̅ exhibits the first logical level H, the first and second switch transistors M1 and M2 are not conducted while the third and fourth switch transistors M3 and M4 are conducted. Equivalent circuit of the pump system 400 in this case is substantially the same as that shown either in FIG. 11 or 13, depending on the conduction state of the first and second transistors MS1 and MS2.

As previously discussed in the embodiment shown in FIG. 9, when the first and second transistors MS1 and MS2 conduct, current charging the load capacitor CL is relatively great. As a result, a relatively short time is required to increase the supply voltage Vpump from a drastically reduced voltage level of about 1.5V back to a desired voltage level of about 3.0V.

In an embodiment, each of the first and second transistors MS1 and MS2, the first, second, third and fourth switch transistors M1, M2, M3 and M4 includes a metal-oxide-semiconductor field-effect transistor (MOSFET). In another embodiment, the transistor includes a high voltage MOSFET capable of operating at 700 volts or above. Alternatively, the transistor includes bipolar junction transistors (BJTs), complementary MOS (CMOS) transistors, or the like. In one or more embodiments, the transistor includes a power field-effect transistor (FET), such as a double-diffused metal-oxide-semiconductor (DMOS) transistor. In yet other embodiments, the transistor includes another suitable device, such as an insulated-gate bipolar transistor (IGBT), a field effect transistor (FET), or the like.

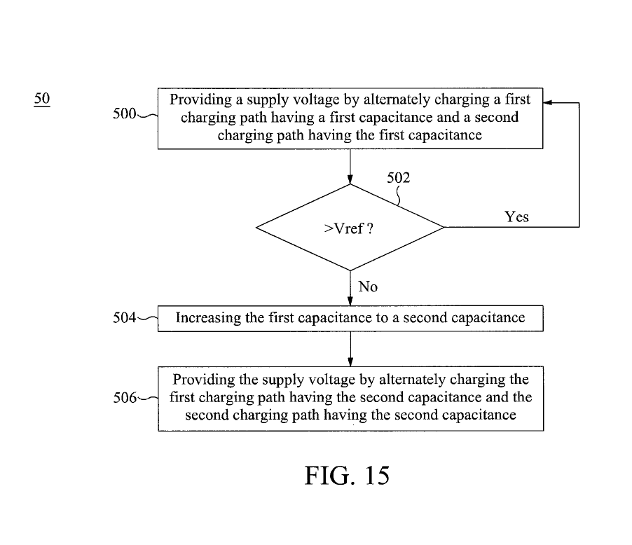

FIG. 15 is a flow diagram illustrating a method 50 of operating a voltage system, in accordance with an embodiment of the present disclosure. Referring to FIG. 15, the method 50 includes operations 500, 502, 504 and 506. The method 90 begins with operation 500, in which a supply voltage is provided by alternately charging a first charging path having a first capacitance in combination with a load capacitor and a second charging path having the first capacitance in combination with the load capacitor.

The method 90 then continues with operation 502, in which it is determined whether a voltage level of the supply voltage is greater than a reference voltage level. If affirmative, the method returns to operation 500. If negative, the method proceeds to operation 504, in which the first capacitance increases to a second capacitance. Subsequent to operation 504, in operation 506, the supply voltage is provided by alternately charging the first charging path having the second capacitance in combination with the load capacitor and the second charging path having the second capacitance in combination with the load capacitor.

In the present disclosure, since the first charging paths CP1, CP11 and CP41 and the second charging paths CP2, CP21 and CP42 have relatively great capacitance, current charging the load capacitor C1 is relatively great. As a result, a relatively short time is required to increase the supply voltage Vpump from a drastically reduced voltage level of about 1.5V back to a desired voltage level of about 3.0V

In contrast, in the comparative pump system 10, in a scenario, the supply voltage Vpump0 of the voltage system 10 may drop drastically. However, the total capacitance Ctotal associated with the first charging path C1 or the second charging path C2 in such scenario is equal to that in a circumstance when the voltage level of the supply voltage Vpump0 is only slightly reduced, for example, from about 3.0V to about 2.8V. As a result, the current I in such scenario is equal to that in the circumstance. In that case, a relatively long time is required to increase the supply voltage Vpump0 from a drastically reduced voltage level of about 1.5V back to a desired voltage level of about 3.0V.

One aspect of the present disclosure provides a voltage system. The voltage system includes a pump system. The pump system includes a first charging path, a second charging path and a load capacitor. The load capacitor is chargeable in combination with the first charging path and the second charging path in an alternate manner. The first charging path exhibits a first capacitance when a voltage level of a supply voltage of the pump system is greater than a reference voltage level, and exhibits a second capacitance greater than the first capacitance when the voltage level of the supply voltage is less than the reference voltage level

Another aspect of the present disclosure provides a voltage system. The voltage system includes a pump system. The pump system includes a first charging path, a second charging path and a load capacitor. The first charging path includes a first capacitor, a first auxiliary capacitor and a first transistor. A terminal of the first auxiliary capacitor is coupled to a terminal of the first capacitor. A source of the first transistor is coupled to the other terminal of the first capacitor and a drain of the first transistor being coupled to the other terminal of the first auxiliary capacitor. The load capacitor is chargeable in combination with the first charging path and the second charging path in an alternate manner. The load capacitor is coupled to the terminals of the first capacitor and the first auxiliary capacitor when the load capacitor is charged in combination with the first charging path.

Another aspect of the present disclosure provides a method of operating a voltage system. The method includes providing a supply voltage of the voltage system by alternately charging a first capacitor having a first capacitance and a second capacitor having the first capacitance until a voltage level of the supply voltage is less than a reference voltage level; increasing the first capacitance to a second capacitance when the voltage level of the supply voltage is less than the reference voltage level; and providing the supply voltage by alternately charging the first capacitor having the second capacitance and the second capacitor having the second capacitance.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, and composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A voltage system, comprising:
a pump system including:
a first charging path;
a second charging path; and
a load capacitor chargeable in combination with the first charging path and the second charging path in an alternate manner,
wherein the first charging path is configured to exhibit a first capacitance when a voltage level of a supply voltage of the pump system is greater than a reference voltage level, and to exhibit a second capacitance greater than the first capacitance when the voltage level of the supply voltage is less than the reference voltage level.

2. The voltage system of claim 1, further comprising:
a sensing device configured to compare the voltage level of the supply voltage to the reference voltage level, wherein the first charging path exhibits one of the first capacitance and the second capacitance based on the comparison result.

3. The voltage system of claim 1, wherein the second charging path is configured to exhibit the first capacitance when the voltage level of the supply voltage is greater than the reference voltage level, and to exhibit the second capacitance when the voltage level of the supply voltage is less than the reference voltage level.

4. The voltage system of claim 1, further comprising:
a switch device configured to couple the load capacitor to the first charging path and couple the load capacitor to the second charging path in an alternate manner.

5. The voltage system of claim 1, wherein the first charging path and the load capacitor are charged by means of a first clock signal, and the second charging path and the load capacitor are charged by means of a second clock signal, wherein the second clock signal is an inverted clock signal of the first clock signal.

6. The voltage system of claim 1, wherein the first charging path includes:
a first capacitor; and
a first auxiliary capacitor configured to be connected in parallel with the first capacitor with respect to the load capacitor when the voltage level of the supply voltage is less than the reference voltage level.

7. The voltage system of claim 6, wherein the first charging path further includes:
a first switch configured to connect the first capacitor to the first auxiliary capacitor in parallel with respect to the load capacitor when the voltage level of the supply voltage is less than the reference voltage level.

8. The voltage system of claim 7, wherein the first switch and the first auxiliary capacitor are connected in series with respect to the load capacitor when the voltage level of the supply voltage is less than the reference voltage level.

9. The voltage system of claim 7, further comprising:
a sensing device configured to compare the voltage level of the supply voltage to the reference voltage level, wherein the first switch either connects or disconnects the first capacitor to the first auxiliary capacitor based on the comparison result.

10. The voltage system of claim 7, wherein the second charging path includes:
a second capacitor; and
a second auxiliary capacitor configured to be connected in parallel with the second capacitor with respect to the load capacitor when the voltage level of the supply voltage is less than the reference voltage level.

11. The voltage system of claim 10, wherein the second charging path further includes:
a second switch configured to connect the second capacitor to the second auxiliary capacitor in parallel with respect to the load capacitor when the voltage level of the supply voltage is less than the reference voltage level.

12. The voltage system of claim 11, further comprising:
a sensing device configured to compare the voltage level of the supply voltage to the reference voltage level, wherein the first switch either connects or disconnects the first capacitor to the first auxiliary capacitor based on the comparison result, and the second switch either connects or disconnects the second capacitor to the second auxiliary capacitor based on the comparison result.

13. A voltage system, comprising:
a pump system including:
a first charging path including:
a first capacitor;
a first auxiliary capacitor, a terminal of the first auxiliary capacitor being coupled to a terminal of the first capacitor; and
a first transistor, a source of the first transistor being coupled to the other terminal of the first capacitor and a drain of the first transistor being coupled to the other terminal of the first auxiliary capacitor;
a second charging path; and
a load capacitor chargeable in combination with the first charging path and the second charging path in an alternate manner, wherein the load capacitor is coupled to the terminals of the first capacitor and the first auxiliary capacitor when the load capacitor is charged in combination with the first charging path.

14. The voltage system of claim 13, wherein the source of the first transistor is directly coupled to the other terminal of the first capacitor, and the drain of the first transistor is directly coupled to the other terminal of the first auxiliary capacitor.

15. The voltage system of claim 14, wherein the terminal of the first capacitor is directly coupled to the terminal of the first auxiliary capacitor.

16. The voltage system of claim 14, further comprising:
a sensing device configured to compare the voltage level of the supply voltage to the reference voltage level, and control the conduction state of the first transistor by controlling a gate voltage of a gate of the first transistor based on the comparison result.

17. The voltage system of claim 13, wherein the second charging path includes:
a second capacitor;
a second auxiliary capacitor, a terminal of the second auxiliary capacitor being coupled to a terminal of the second capacitor; and
a second transistor, a source of the second transistor being coupled to the other terminal of the second capacitor and a drain of the second transistor being coupled to the other terminal of the second auxiliary capacitor.

18. The voltage system of claim 13, wherein the pump system further comprises:
a first switch transistor;
a second switch transistor connected in series with the first switch transistor with respect to the load capacitor, wherein the connected first and second switch transistor is coupled between the terminal of the first capacitor and the load capacitor when the load capacitor is charged in combination with the first charging path;
a third switch transistor; and
a fourth switch transistor connected in series with the third switch transistor with respect to the load capacitor, wherein the connected third and fourth switch transistor is coupled between the terminal of the second capacitor and the load capacitor when the load capacitor is charged in combination with the second charging path.

19. A method of operating a voltage system, comprising:
providing a supply voltage of the voltage system by alternately charging a first capacitor having a first capacitance and a second capacitor having the first capacitance until a voltage level of the supply voltage is less than a reference voltage level;
increasing the first capacitance to a second capacitance when the voltage level of the supply voltage is less than the reference voltage level; and
providing the supply voltage by alternately charging the first capacitor having the second capacitance and the second capacitor having the second capacitance.

20. The method of claim 19, further comprising:
determining whether the voltage level of the supply voltage is less than the reference voltage level.
